(19) United States
(12) Patent Application Publication
(10) Pub. No.: US 2005/0103198 A1
(43) Pub. Date: May 19, 2005

(54) Machine for preparing beverages

(76) Inventor: Luca M Doglioni, Monti (IT)

Correspondence Address: NIXON & VANDERHYE, PC, 1100 N GLEBE ROAD, 8TH FLOOR, ARLINGTON, VA, 22201-4714, US

(21) Appl. No.: 10/511,342

(22) PCT Filed: Apr. 18, 2002
(86) PCT No.: PCT/IT02/00249

(51) Int. Cl. A23L 1/00

(52) U.S. Cl. 99/275

(57) ABSTRACT

It is disclosed a machine for the preparation of beverages, of the type comprising at least one dispensing unit that includes a removable collecting device. The access to the latter is through a window obtained in the envelope, and at least one covering element is provided that comprises sliding guide means complementary to those associated to the access window.

### TECHNICAL FIELD OF THE INVENTION

The present invention relates to a machine for the preparation of beverages, for instance a machine suitable for the preparation of a beverage starting from disposable containers, such as cartridges or the like.

### BACKGROUND OF THE INVENTION

Generally, in the machines of the known art of this type, at least one dispensing unit is present that is housed in the inside of an envelope. In particular, the dispensing unit comprises at least one collecting unit which can be removed for the necessary cleaning operations. The mounting of the collecting device in the dispensing unit is generally realized by means of a bayonet-coupling.

The same collecting device has in the lower part a dispensing duct wherefrom the beverage prepared comes out to be in its turn conveyed through a duct that ends in the dispensing spout. The after is obtained in an underlying covering plate that can be removed to allow the access to, and the removal of, the collecting device.

As is obvious, the access to the collecting device in the mounting and removal operations is poorly practical and particularly tiresome. The collecting device, in fact, can be reached only by operating manually from the bottom of the dispensing duct. Besides being tiresome from the point of view of the operations necessary to place the collecting device in a bayonet-coupling system, it is worth stressing that there may arise health problems, as the “clean” collecting device is re-positioned by operating with a hand on the dispensing duct of the collecting device.

A general object of the present invention is to provide a machine for dispensing beverages such as to render easier and safer for health the frequent operations which the collecting device is submitted to.

A particular object of the present invention is to provide a machine for dispensing beverages such as to facilitate the access to the collecting device.

Another particular object of the present invention is to provide a machine for dispensing beverages such as to facilitate the mounting and removal of the collecting device.

### SUMMARY OF THE INVENTION

These objects are achieved by the present invention that relates to a machine for the preparation of beverages, of the type comprising at least one dispensing unit housed in the inside of an envelope, said dispensing unit comprising at least one removable collecting device whose access is through at least one access window obtained in the envelope, and at least one removable covering element to occlude or selectively free the access window, characterized in that the access window faces the collecting device, and that the at least one covering element and the at least one access window comprise sliding guide means that are complementary to each other.

In this way, it is possible to have access to the dispensing unit from the front and to operate directly on the bayonet-coupling by which the collecting device is held.

The sliding guide means are oriented according to a sliding direction substantially parallel to the axis of the collecting device. Hence, one only vertical movement suffices to remove the covering element from the rest of the envelope.

Suitably, locking means are provided to keep the covering element in the access window occluding position, such as for instance elastic snap-locking means.

Preferably, the collecting device comprises at least one protruding handling portion to facilitate the positioning and the removal of said collecting device with respect to the dispensing unit. Besides facilitating the engagement and disengagement of the bayonet-coupling, this characteristic is more advantageous also from the point of view of health, as it allows the manipulation of the collecting device without touching the zones concerned by the passage of the dispensed beverages.

Advantageously, the covering element comprises guide means that loosely engage the protruding handling portion when the collecting device is correctly mounted. In this manner, a key-mechanism is obtained that prevents the access window from closing if the collecting device is not correctly mounted in the bayonet-coupling.

### BRIEF DESCRIPTION OF THE DRAWINGS

Further advantages and characteristics of the present invention will be clearer thanks to the following description wherein reference is made to the attached drawings, wherein:

FIG. 1 shows a portion of a machine for beverage dispensing according to the present invention, in correspondence of the access window to the dispensing unit;

FIG. 2 is a perspective view of a covering element for a machine according to the present invention;

FIG. 3 is a perspective view of a collecting device for a machine according to the present invention;

FIG. 4 is another perspective view of the covering element of FIG. 2; and

FIG. 5 is a view that shows the coupling between the collecting device of FIG. 3 and the covering element of FIG. 4.

### MODES FOR CARRYING OUT THE INVENTION

FIG. 1 shows a portion of a machine for the preparation of beverages 10 in correspondence of window 20 allowing the access to the dispensing unit. For the sake of representation clearness, some details have been omitted, for instance the bayonet-coupling wherein the collecting device 40 engages.

In the represented embodiment, envelope 11 of machine 10 also comprises an opening 12 allowing the insertion and the removal of a disposable cartridge (not shown) containing a preparation for the beverage to be dispensed.

In correspondence of the access window 20, envelope 11 comprises edge portions 21 placed on the opposite sides of the window, which are provided for engaging in a sliding manner the inside of guide grooves 31 obtained on the opposite sides of at least a first wall 34 of a covering element 30.

The restraining of the covering element 30 in the occluding position of the access window 20 is realized, for instance, by locking elastic snap-means. In the embodiment shown herein, the locking elastic snap-means are realized, for instance, with one or more protrusions 32 obtained on elastically deformable arms 33, intended for engaging in special seats 22 obtained in a suitable position in the inside of machine 10.

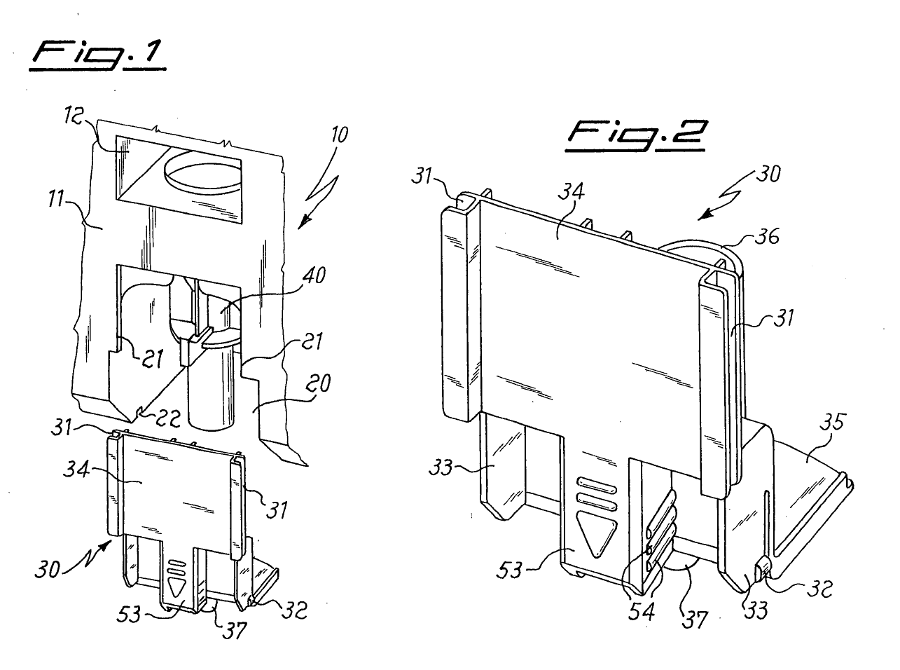

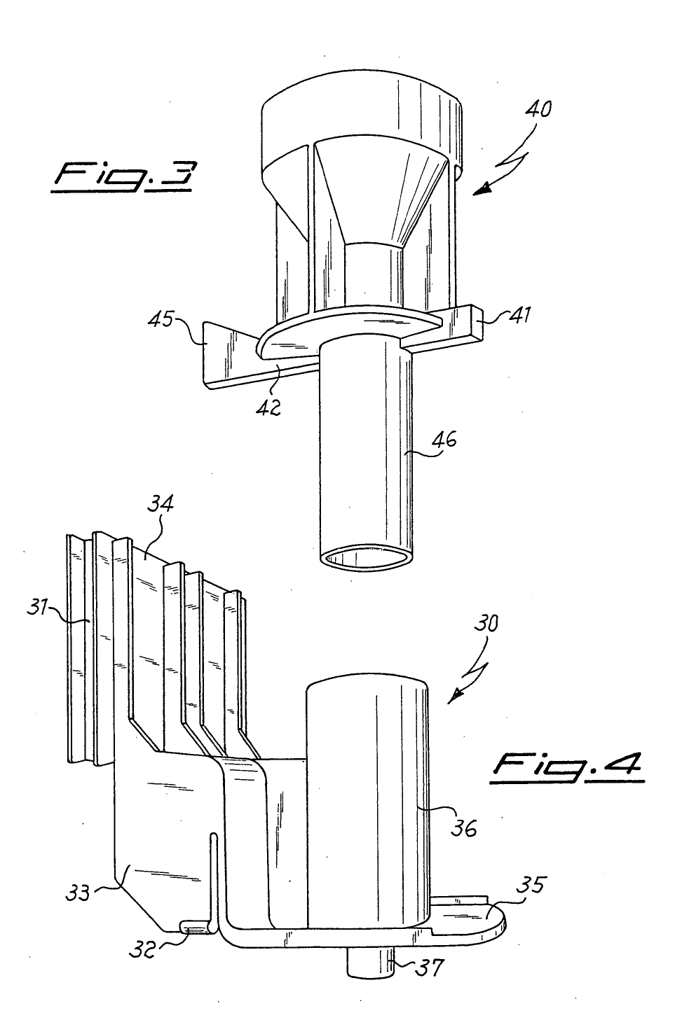

The covering element 30, shown with more details in FIGS. 2 and 4, which, for instance, may be realized from plastic material, comprises in particular a first substantially flat wall portion 34, parallel to the vertical axis of the collecting device 40 when the covering element 30 is slidingly engaged in the access window 20.

On the external front part of the covering element 30, below the first portion of wall 34, a handling portion 35 is obtained that is provided, for instance, with protruding ribs 54, to facilitate the manual operations of positioning and removing the covering element 30.

The covering element 30 also comprises a second wall portion 35 substantially perpendicular to the first wall portion 34. In the embodiment shown herein, the second wall portion 35 is integral with the first wall portion 34, but it is also possible to provide the wall portions as separate parts by providing means for connecting the separate parts in an articulated manner, or means allowing also the removable positioning of the part comprising the second wall portion 35.

The covering element 30 also comprises a tubular portion 36 having a through-hole whose axis is perpendicular to the second wall portion 35. The tubular portion 36 is composed of a duct that ends in a dispensing spout 37 wherefrom the prepared beverage comes out to be collected in a cup or a glass already placed under said spout.

The tubular portion 36 has an internal diameter greater than the external diameter of the dispensing duct 46 (FIG. 3) of the collecting device 40, in such a manner that, when the covering element 30 is in the position occluding the access window 20, the dispensing duct 46 is housed at least partly in the inside of the tubular portion 36.

The collecting device 40, shown with more details in FIG. 3, is of the type intended for being engaged in a bayonet-coupling. A first protruding arm 41 of the bayonet coupling is therefore provided, while in a diametrically opposed position the second arm 42 of the bayonet coupling extends to form a protruding handling portion 45 that allows the manipulation of the collecting device 40 in an easier and health-safer manner.

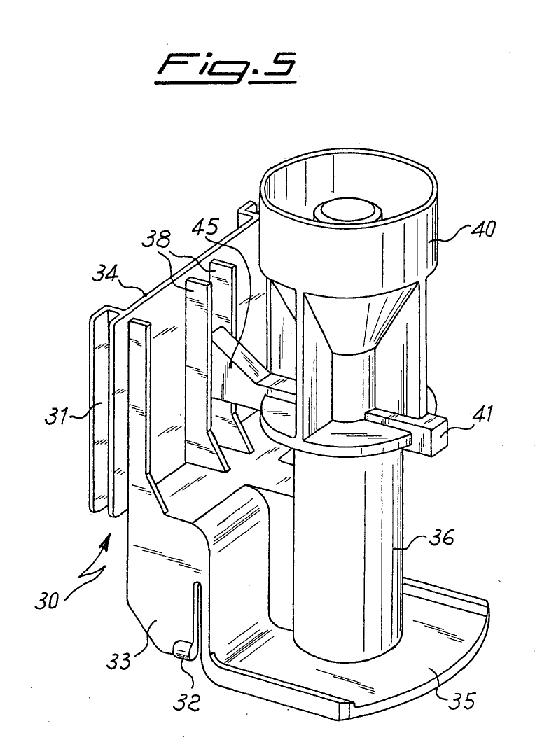

FIG. 5 shows the assembly composed of a covering element 30 and a collecting device 40 in a mutual coupling position, i.e. in the state where the covering element is in the position that occludes the access window 20. As can be observed, the covering element 30 advantageously comprises guide means, consisting for instance of a couple of flanges 38 that loosely engage the protruding handling portion 45 in such a manner as to realize a key-mechanism that prevents the covering element 30 from closing if the collecting device is not correctly mounted in the bayonet-coupling.

1. A machine for the preparation of beverages of the type comprising at least one dispensing unit housed in the inside of an envelope, said dispensing unit comprising at least one removable collecting device whose access is through at least one access window obtained in the envelope, and at least one removable covering element to occlude or selectively free said access window, characterized in that the access window faces the collecting device, and that said at least one covering element and said at least one access window comprise sliding guide means that are complementary to each other.

2. A machine according to claim 1, wherein said at least one removable covering element and said at least one access window comprise locking means for holding said covering element in the occluding position of said access window.

3. A machine according to claim 2, wherein said locking means are elastic snap-locking means.

4. A machine according to claim 1, wherein said at least one removable covering element comprises at least one substantially flat first wall portion, said at least one substantially flat first wall portion being parallel to the vertical axis of said collecting device when said covering element is slidingly engaged in said access window.

5. A machine according to claim 4, wherein said sliding guide means consist of at least a couple of grooves obtained on the opposite sides of said at least one first wall portion.

6. A machine according to claim 1, wherein said at least one covering element comprises a second wall portion substantially perpendicular to a first wall portion.

7. A machine according to claim 6, wherein said at least one covering element further comprises at least one tubular portion having a through-hole whose axis is perpendicular to said at least one second wall portion and suitable to house in its inside at least part of the beverage dispensing duct of said collecting device.

8. A machine according to claim 0.1, wherein said collecting device is removably mounted in said dispensing unit by means of a bayonet-coupling, and wherein said collecting device comprises at least one protruding handling portion, to facilitate the positioning and the removal of said collecting device with respect to said dispensing unit.

9. A machine according to claim 8, wherein said at least one covering element comprises guide means that loosely engage said at least one protruding handling portion when said collecting device is correctly mounted.

10. A machine according to claim 1, wherein said sliding guide means complementary to each other are oriented according to a sliding direction substantially parallel to the axis of said collecting device.
